(19) United States
(12) Patent Application Publication
(10) Pub. No.: US 2009/0150192 A1
(43) Pub. Date: Jun. 11, 2009

(54) METHOD AND SYSTEM FOR CALCULATING THE PREMIUMS AND BENEFITS OF LIFE INSURANCE AND RELATED RISK PRODUCTS BASED ON PARTICIPATION IN A WELLNESS PROGRAM

(75) Inventors: Adrian GORE, Johannesburg (ZA); Alan POLLARD, Sandlon (ZA); Craig NOSSEL, Victory Park (ZA); Arthur C. CARLOS, Park Ridge, IL (US); Francois MILLARD, Chicago, IL (US)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: Discovery Holdings Limited, Sandton (ZA)

(21) Appl. No.: 12/333,465

(22) Filed: Dec. 12, 2008

Related U.S. Application Data
(63) Continuation-in-part of application No. 12/112,165, filed on Apr. 30, 2008.
Application No. 12/112,165 is a continuation-in-part of application No. 09/982,274, filed on Oct. 17, 2001.
Application No. 09/982,274 is a continuation-in-part of application No. 09/265,240, filed on Mar. 9, 1999, now abandoned.

(30) Foreign Application Priority Data
Mar. 10, 1998 (ZA) 09/2005
Dec. 30, 1998 (ZA) 98/11943

(51) Int. Cl. G06Q 40/00

(52) U.S. Cl. 705/4

(57) ABSTRACT

A method, information processing system, and computer program storage product dynamically manage risk coverage premiums. A given time period is determined to have expired. A risk coverage premium associated with a policy holder is retrieved. A wellness program status level is determined to be associated with the policy holder. A current risk coverage premium is dynamically adjusted based on the current wellness program status level.

### CROSS-REFERENCE TO RELATED APPLICATIONS

This application is a continuation-in-part of U.S. patent application Ser. No. 12/112,165 filed Apr. 30, 2008, which is a continuation-in-part of U.S. patent application Ser. No. 09/982,274 filed on Oct. 17, 2001 now [pending] which is a continuation-in-part application of U.S. application Ser. No. 09/265,240 filed Mar. 9, 1999, each application is hereby incorporated by reference in its entirety.

### FIELD OF THE INVENTION

The present invention generally relates to the field of risk coverage and more particularly relates to dynamic risk coverage premiums based on a policy holder's lifestyle actions.

### BACKGROUND OF THE INVENTION

Generally, risk coverage providers such as life insurance, critical illness, and long term care providers have traditionally calculated risk coverage premiums on a person's risk profile when he/she applies for coverage. Once this initial premium is calculated it typically remains unchanged or can increase or decrease a predetermined amount at a predetermined time period that is established when coverage is granted. For example, a premium can increase annually based on an index such as inflation or can increase based on an age specific amount reflecting a higher risk as the policy holder ages. Because the policy holder's risk is assessed up-front, the extent to which the policy holder preserves his/her health status through positive or negative lifestyle actions and choices does not have any bearing on future premiums.

### SUMMARY OF THE INVENTION

In one embodiment, a method for dynamically managing risk coverage premiums is disclosed. The method includes determining that a given time period has expired. A risk coverage premium associated with a policy holder is retrieved. A wellness program status level is determined to be associated with the policy holder. A current risk coverage premium is dynamically adjusted based on the current wellness program status level.

In another embodiment an information processing system for dynamically managing risk coverage premiums is disclosed. The information processing system includes a memory and a processor that is communicatively coupled to the memory. A premium calculator is communicatively coupled to the memory and the processor. The premium calculator is adapted to determine that a given time period has expired. A risk coverage premium associated with a policy holder is retrieved. A wellness program status level is determined to be associated with the policy holder. A current risk coverage premium is dynamically adjusted based on the current wellness program status level.

In yet another embodiment, a computer program storage product for dynamically managing risk coverage premiums is disclosed. The computer program storage product includes instructions for determining that a given time period has expired. A risk coverage premium associated with a policy holder is retrieved. A wellness program status level is determined to be associated with the policy holder. A current risk coverage premium is dynamically adjusted based on the current wellness program status level.

### BRIEF DESCRIPTION OF THE DRAWINGS

FIG. 1 is a block diagram illustrating a general overview of an operating environment according to one embodiment of the present invention;

FIG. 2 illustrates one example of a user participation information according to one embodiment of the present invention;

FIG. 3 illustrates one example of a wellness program user information according to one embodiment of the present invention;

FIG. 4 is an operational flow diagram illustrating one process for determining a wellness status of a risk coverage policy holder according to one embodiment of the present invention;

FIG. 5 is an operational flow diagram illustrating one process for dynamically adjusting a risk coverage premium based on a wellness program status of a policy holder according to one embodiment of the present invention; and

FIG. 6 is a block diagram illustrating a detailed view of an information processing system according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Operating Environment

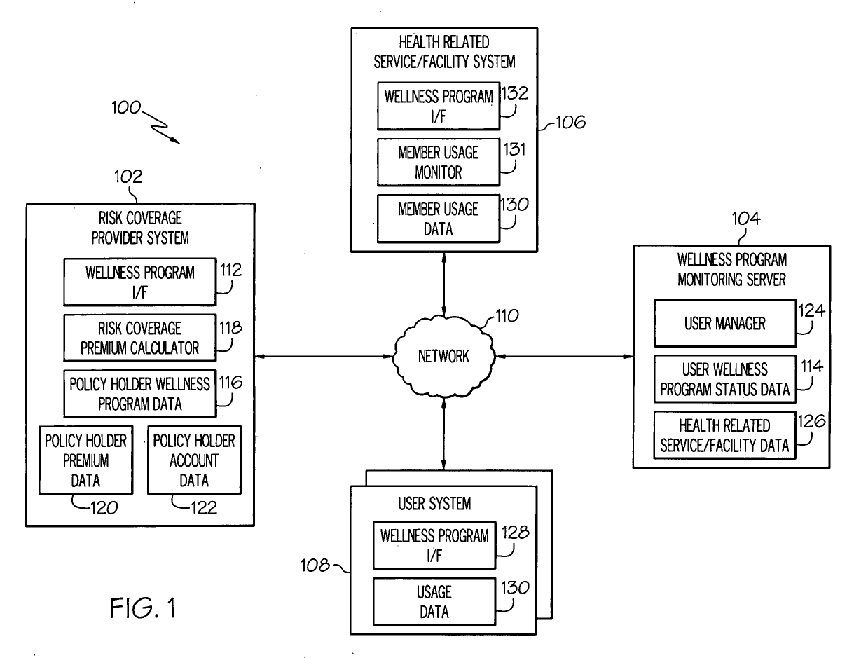

FIG. 1 illustrates one example of an operating environment 100 according to one embodiment of the present invention. The operating environment 100 of FIG. 1 allows risk coverage providers such as life insurance provider, a critical illness insurance provider, a long term care provider, or the like to provide wellness enabled risk coverage, which is risk coverage that can be dynamically adjusted based on a policy holder's participation in one or more wellness programs. The risk coverage providers are able to provide dynamic risk coverage premiums to its policy holders. For example, risk coverage premiums are not required to be static or based on information obtained at the time of applying for risk coverage. Risk premiums can be increased and/or decreased throughout the duration of coverage based whether a policy holder is maintaining a healthy or unhealthy lifestyle.

In particular, FIG. 1 shows a plurality of information processing systems 102, 104, 106, 108 communicatively coupled to each other via one or more networks 110, which can be wired and/or wireless networks. These information processing systems are a risk coverage provider system 102, a wellness program monitoring system 104, one or more health related service/facility system 106, and one or more user systems 108. The risk coverage system 102 is associated with a risk coverage provider such as life insurance provider, a critical illness insurance provider, a long term care provider, or the like.

The risk coverage system 102, in one embodiment, includes a wellness program interface 112 that allows one or more risk coverage provider employees to access and interact with the wellness program monitoring system or server 104. For example, a risk coverage provider employee can use the wellness program interface 112 to retrieve/obtain wellness program related data 114 and store it locally as policy holder wellness program data 116. The wellness program interface 112 also allows the wellness program monitoring server 104 to automatically and without user intervention send user wellness program data to the risk coverage provider system at given intervals or when the data 114 has been updated at the wellness program monitoring server 104. The local policy holder wellness program data 116 and the user wellness program data 114 at the wellness program server are discussed in greater detail below.

The risk coverage system 102 also includes a risk coverage premium calculator 118 that calculates a risk coverage premium for policy holders. For example, the calculator 118 can calculate an initial premium for an individual when the individual first applies for coverage and can also dynamically adjust the premium based on whether the policy holder is maintaining a healthy or unhealthy lifestyle. The calculator 118 determines whether the policy holder is maintaining a healthy or unhealthy lifestyle based on the policy holder wellness program data 116. The premium calculation process is discussed in greater detail below. The policy holder premium data can be stored in one or more databases 120. The risk coverage system 102 can also maintain policy holder account data 122 that can include account information such as the amount of death benefit or other risk coverage selected. The account policy holder account data 122 is discussed in greater detail below.

The wellness program monitoring server 104, in one embodiment, is associated with one or more entities that provide a wellness program to individuals, employers, and/or risk coverage providers. For example, an individual can subscribe to a wellness program in order to obtain dynamic reductions in risk coverage premiums; employers can offer one or more wellness programs to their employees in order to obtain dynamic risk coverage premium reductions; and the risk coverage providers can provide wellness programs as a service to its policy holders so that the policy holders can obtain dynamic reductions in risk coverage premiums. A wellness program is associated with one or more facilities such as (but not limited to) a health club, hospital, outpatient center, pathology center and/or one or more services such as (but not limited to) health coaching, smoking cessation, nutritional services and support groups. These health related facilities/services can be offered to the policy holder by the risk coverage provider, employer of the policy holder, and/or the wellness program management company. A wellness program can also offer incentives such as shopping discounts, monetary rewards, and the like based on usage of the health related facilities/services. One example of a wellness program is Discovery Holding's Vitality program.

The wellness programs can be owned, operated, and managed by a third party where the employers and/or risk coverage providers subscribe to this third party service or the employers and/or risk coverage providers can own, operate, and manage the wellness programs themselves. By providing incentives such as reductions in risk coverage premiums to participate in wellness programs the policy holders maintain healthier lifestyles and receive ongoing reductions of their premiums while the risk coverage provider experiences less pay outs, claims, and the like. The wellness program and data 114 is discussed in greater detail below.

The wellness program monitoring server 104 also includes health related facility/service data 126. For example, health related facility/service data 126 can include information regarding all of the health related facilities/services available for a particular wellness program. The health related facility/service data 126 can also identify which risk coverage providers, employers, and/or individuals, are associated with a given health related facility/service. For example, the risk coverage provider may want all available health related facilities/services offered to its policy holders or a particular subset of health related facilities/services.

The wellness program monitoring server 104 can receive health related facility/service usage data (e.g., user wellness program data 114) that comprises an individual's usage information such as time of participation, frequency of participation, participation duration, program completion status, and the like from either the individual, the health related facility/service, or the risk coverage provider (or employee). For example, a policy holder (e.g., the individual) can interact with the wellness program monitoring server 104 via a wellness program monitoring server interface 128 at the user system 108 to upload health related facility/service usage data 130 to the wellness program monitoring server 104, which is then stored as user wellness program data 114. To prevent the policy holder from uploading false or forged data, the usage data, in one embodiment, is required to be verifiable by using digital signatures or any other authentication mechanism. For example, the user can receive usage data from a health related facility/service via email with a digital signature of that particular facility/service. Therefore, the wellness program monitoring server 104 can verify the usage data submitted by the policy holder.

Alternatively, the health related facility/service itself can submit usage data 130 to the wellness program monitoring server 104 that is maintained and managed by a member usage monitor 131. For example, an administrator at the health related facility/service can upload the usage data 130 via the wellness program interface 132 to the wellness program monitoring server 104, which is then stored as user wellness program data 114. In another embodiment, the health related facility/service system 106 automatically and without user intervention transmits the usage data 130 to the wellness program monitoring server 104.

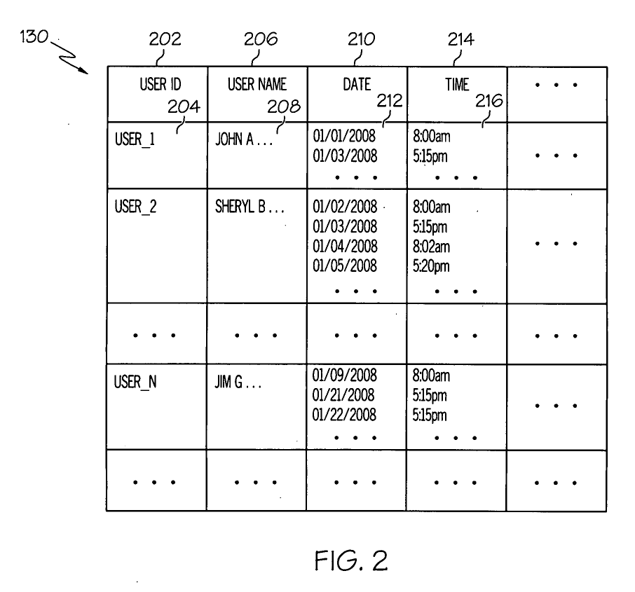

FIG. 2 shows one example of user participation information 200 that can be stored at the health related facility/service as usage data 130 and/or stored at the wellness program monitoring server 104 as user wellness program data 114. In particular, the user participation information 200 includes a “User ID” column 202 that includes entries 204 with a unique identifier such as “User_{—}1”. These identifiers uniquely identify each user of the facility, service, or activity. A “User Name” column 206 includes entries 208 with a user's name. For example, the user ID “204” is associated with “John A”. A “Date” column 210 includes entries 212 indicating the date(s) that a user associated with the entry 212 utilized the facility or participated in a service/activity. A “Time” column 214 includes entries 216 with time information corresponding to the date information under the “Date” column 210. Additional columns such as a column that identifies what services/facilities where used can also be added. It should be noted that one or more columns can be added and/or deleted.

In another embodiment, the policy holders and/or the health related facilities/services can transmit usage data to the risk coverage provider system 102, which is stored as policy holder wellness program data 116. In this embodiment, the risk coverage provider system 102 transmits the usage data to the wellness program monitoring server 104. It should be noted that the wellness program monitoring server 104 can also query the health related facility/service system 106, user system 108, and/or the risk coverage provider system 102 for usage data.

Once the usage data has been collected at the wellness program monitoring server 104, the wellness program manager 124 determines a wellness program status for each user (e.g., policy holder) based on the usage data received for each user, as discussed above. It should be noted that in other embodiments, the wellness program status can also be based on other data such as insurance claims as well. The wellness program status information is stored at the wellness program monitoring server 204 as part of the user wellness program data 114. This information 114 is then transmitted to the risk coverage provider system 102 where the risk coverage premium calculator 118 determines how the risk premium for a policy holder associated with information 114 received from the wellness server 102 is to be adjusted (i.e. increased or decreased) if at all. The wellness program status and the dynamic risk coverage premium calculations are discussed in greater detail below. It should be noted that the wellness program monitoring server 104 can be part of the risk coverage provider system 102 and not be associated with a separate entity.

Dynamically Updating Risk Coverage Premiums

As discussed above, the various embodiments of the present invention enable a risk coverage provider to dynamically update a policy holder's risk coverage premiums based on the policy holder maintaining or failing to maintain a healthy lifestyle. Stated differently, the wellness enabled risk coverage of the various embodiments of the present invention varies premiums in an ongoing manner based on actions a policy holder takes to maintain a healthy lifestyle. As such, the premium calculator 118 can lower premiums for those maintaining a healthy lifestyle or increase premiums for those who fail to demonstrate a healthy lifestyle. These embodiments, therefore, provide risk coverage with a dynamic underwriting mechanism.

Initially, an individual applies for risk coverage and an initial premium is calculated by the premium calculator 118. This initial premium information is stored in the policy holder premium database 120. In addition to premium amounts, the premium information can include payment type information such as level or decreasing and indexed. A level or decreasing payment type indicates that the premium may change annually at the policy anniversary based on a wellness program status associated with the policy holder (this is discussed in greater detail below). An indexed payment type indicates that if the plan has an indexed account structure the premium increases annually at the policy anniversary by the total of the percentage in the selected index such as the retail price index. This percentage rise is subject to maximum and/or minimum percentages in any one year. Additional factors can also be used to determine the increase as well.

Also, policy account information 122 associated with the policy holder is stored in a database. Policy account information 122 can indicate, for example, the amount of death benefit or other risk coverage selected and that is available. The policy account information 122 can also indicate any required policies such as life insurance, critical illness, or the like. The policy account information 122 can further indicate plan structure such as (but not limited to) level, indexed, decreasing. A level plan remains level throughout the duration of the policy. In other words, the death or critical illness benefit selected by the policy holder does not change over the coverage period. An indexed plan is increased annually at the policy anniversary in line with a selected index such as the retail price index. This type of plan is subject to a maximum and/or a minimum percentage in any one year. A decreasing plan decreases annually in a predetermined manner, for example, in line with the capital outstanding on a notional repayment mortgage.

As discussed above, the initial premium calculated by the premium calculator 118 can be dynamically adjusted based on a user's participation or non-participation in one or more wellness programs. A wellness program according to one embodiment of the present invention allows a risk coverage provider to assess the risk of a policy holder or potential policy holder. For example, the risk coverage provider can identify an individual's key risk factors upfront and recommend a risk plan with person specific goals, activities and incentives to improve risk factors or maintain a healthy lifestyle. The wellness program can educate the policy holder by using exhaustive database to provide medical condition and lifestyle guidance to the policy holder. This guidance can be customized to an individual's health risk. The wellness program can also promote prevention by requiring and/or rewarding age and gender specific preventative care activities (annual visits, pap smear, mammogram, colonoscopy, flu shots, immunizations, etc). The wellness program can also promote fitness by requiring and/or rewarding fitness activities. For example the program can provide preferential access to fitness facilities and gyms, promotes participation in community fitness activities and daily personal exercise. Verification of activities can take place though attendance records (at gyms), proof of participation (public events) and electronic heart rate monitor records for personal exercise. Healthy lifestyles can also be promoted by the wellness program by requiring and/or rewarding a healthy lifestyle, thereby reducing lifestyle related risk factors (smoking, poor nutrition, stress, alcohol, risky behavior, etc).

By participating in the wellness program and living verifiable healthy lifestyle individuals accumulate points and status (blue, bronze, silver, gold, and platinum, etc.). Increased status is therefore directly attributable to a healthier lifestyle and a reduction in risk factors. Fewer risk factors and risk maintenance have a causal link to longer life, lower and delayed incidence of chronic disease, hence lower healthcare and critical illness cost. Therefore, the various embodiments of the present invention adjust risk based on these verifiable lifestyle and health activities.

The points accumulated by the policy holder, in one embodiment, are based on the policy holder's usage of the health related facilities/services, as discussed above. The wellness program manager 124 awards these points to the policy holder based on the usage information received from either the health and wellness related facilities/services, individuals, and/or the risk coverage provider. In another embodiment, points can be awarded for participation in on line tools and behavior change programs, such as prenatal care or smoking cessation or weight loss programs. The wellness program manager 124 then associates a wellness program status level to each of the policy holders based on the points associated with the policy holder. The points and/or status can be updated every day, week, month, year, at the policy anniversary, renewal dates, or the like. The following is a more detailed discussion on awarding points to a policy holder based on health related facility/service usage and subsequently associating a wellness program status to the policy holder.

As discussed above, the wellness program manager 124 associates a wellness status level with an individual based on participation in the wellness program. The wellness status levels can be such that each level indicates a given degree of participation. As a user increases his/her participation in a wellness program, the status level associated with a user can increase. Similarly, the status level associated with a user can also decrease based on a decrease in participation or a lack of participation. Degrees or levels of participation can be quantified using various methods such as (but not limited) a point system, number of visits to a facility, and number of registrations for a service.

The following discussion illustrates one example of determining a wellness status level for an individual using a point system. Points can be allocated to an individual each time he/she uses a facility or service or based on weekly usage, monthly usage, quarterly usage, or the like. For example, wellness program points are able to be awarded to an individual for joining a health club, using a health club, attending health classes, and for registering with a walk-a-thon. Different points can be award for different activities performed by the individual. For example, 1000 points can be awarded for joining a health club while 100 points can be awarded each time the individual uses a health club. Additional points can be awarded if the member visits a health club for prescribed number of times per week. Also, different points can be awarded for various aspects of a facility or service. For example, an individual may participate in difference classes offered by the health club each having a given number of points assigned thereto.

Other examples of earning points for a wellness program are now given. A smoking cessation program can be part of a wellness program, subject to payment of an activation fee, to all members of the program. Spouses and other dependents of the wellness program members may be eligible for the smoking cessation program for no charge, or at a rate below the standard market rate. Smokers who successfully quit smoking through the smoking cessation program earn wellness program points on submission of a non-smoker declaration, counter-signed by a representative of the smoking cessation program or verifiable blood results (cotanine level). Points are earned, for example, as follows:

Per principal or spouse submitting a declaration—5,000 points.

Points can be re-earned each wellness program year on submission of a new declaration and, or blood test result

A non-smoking wellness program principal member and/or spouse earn, for example, 5,000 wellness points on submission of a non-smoker declaration, with or without further testing, such as a blood draw or urine nicotine test. Points can be re-earned each wellness program year on submission of a new declaration. Another example of a service available for members of a wellness program is a weight reduction program. This is available, subject to payment of an activation fee, to all wellness program principal members. This weight reduction program membership is for the period until the member reaches their goal weight, as long as at least one session per month is attended. A lapse of time, for example less than 6 months, will require a further payment of an activation fee to “reactivate” this facility. A lapse of longer than the specified time may require renewal at the rate below the standard market rate. Wellness program members who have successfully reached their goal weights through a weight reduction program are presented with a certificate to this effect. Submission of this certificate to the wellness program and/or the employer earns wellness points, for example, as follows:

Per member or dependent—5,000 points

To an annual maximum of—10,000 points

Points can be re-earned each wellness program year on submission of a new certificate.

Spouses and other dependents of the wellness program members may be eligible for similar point earning activities and rewards, particularly where the spouse or family is covered under the risk policy.

In addition, wellness program members are encouraged to make use of a medical advice line or website and to make use of preventive care options in order to prevent or minimize medical problems that might otherwise only be detected later, with corresponding higher medical costs. Examples of such preventive care options are as follows. 2,500 wellness points, for example, are awarded when a female member joins a Managed Maternity Program. 5,000 wellness points, for example, are awarded when a child of a wellness program member has completed their series of vaccinations (typically around 18 months of age). Points are awarded during the wellness program year in which the series of vaccinations was completed. The member claims these points by submission of a copy of their clinic card, detailing the completed series of vaccinations. 2,000 wellness points per adult, for example, are awarded each year that the adult is both a registered blood donor and donates at least one pint of blood. The member claims these points by submission of proof of donation (e.g., a copy of their blood donor card issued). 5,000 wellness points, for example, per adult woman (16 years ±) are awarded each year that they have a pap smear. These points can be automatically awarded by interface with the claims system of the medical treatment program, based on practice type and tax code. Examples of other preventative services include annual visits, mammograms and colonoscopies. Wellness points can also be awarded for following preferred procedures, such as pre-authorization of medical treatment, compliance with evidence based medicine guidelines or disease management protocols. Examples of the above are indicated in FIG. 10 of co-pending U.S. patent application Ser. No. 09/982,274, which is hereby incorporated by reference in its entirety.

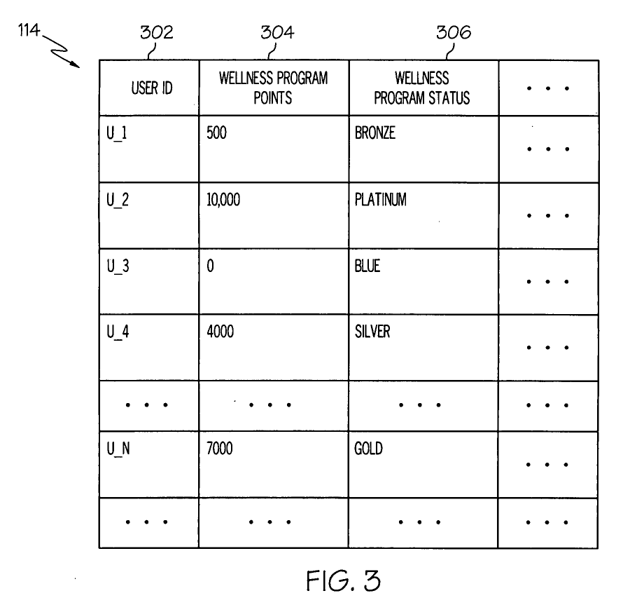

Based on the points accumulated by an individual, the wellness program manager 124 associates a wellness program status level as shown in FIG. 3. FIG. 3 shows additional user wellness program data 114 such as a user identifier 302, a current total point range 304 and an associated status level 306. For example, FIG. 3 shows examples of wellness program status levels such as (but not limited to) “Grace Period”, “Blue/Inactive”, “Bronze”, “Silver”, “Gold”, and “Platinum” under the “Wellness Program Status Level” column 306. It should be noted that these levels are only examples and any form of status/level indication can be used. Each wellness program status level can be associated with a range of points. For example, a first range of points can be associated with a first status level, a second range of points can be associated with a second status level, and so on.

For example, a wellness status of “Blue” is a policy holder's starting level when the product commences. The policy holder may return to this level after a policy anniversary depending on the rules applicable at that time. A status level of “Bronze” indicates a minimal effort on behalf of the policy holder and requires the least amount of effort (e.g., wellness program points) to obtain. For example, a user can obtain a status of “Bronze” by registering with a program and completing a Health Risk Assessment. A status of “Silver” indicates a moderate effort threshold, but regular effort by the policy holder to look after his/her health through a wellness program. A status of “Gold” indicates a strong and regular effort by the policy holder to look after his/her health through the wellness program. A status of “Platinum” indicates a significant and regular effort on behalf of the policy holder to look after his/her health through the wellness program. In one embodiment, the status levels of “Bronze”, “Silver”, “Gold”, and “Platinum” are levels ranging from low to high where a user associated with “Bronze” has a lower status level than a user associated with “Platinum” based on points accumulated by the user. The wellness program manager 124 can update an individual's wellness status level every day, month, quarter, year, or the like. In some embodiments, one or more of the status levels may only be obtainable at given time periods such as at the policy anniversary or renewal time.

In addition to the above embodiments, a wellness program can be customized for an individual based on the individual's lifestyle. Therefore, an individual can follow a personally tailored wellness program rather than having to comply with a general wellness program. In this embodiment, personal information pertaining to a wellness member such policy holder is obtained. The personal information includes at least the individual's age and gender. In addition, health information pertaining to the individual is received. The health information includes lifestyle factors such as exercise, diet, and smoking to name but a few examples, as well as clinical factors such as blood pressure, cholesterol and weight to name but a few examples. For example, the health information includes information relating to the individual's current health and includes at least some of the individual's eating habits, whether they are a smoker or a non-smoker, their exercise habits and whether or not they have any chronic health conditions to name but a few examples.

The personal information and the health related information are then used to determine a tailored wellness program for the individual. The wellness program typically includes a plurality of program areas with which the individual must comply. In addition, the personal information and the health information are used to calculate a relative health risk of the individual and then using the calculated relative health risk of the individual as a factor to determine the reward awarded to the individual. Based on the health and lifestyle factors that include an amount of physical activity, dietary habits, smoking status, as well as existence of certain chronic diseases, the impact of lifestyle behaviours and health parameters for the individual are calculated and shown how this may increase morbidity and mortality. As a result, the points, discussed above, that are available are recalibrated to be weighted according to the individual's health risk factors. In addition, the scoring helps determine which areas the individual needs to focus on for his/her health to improve and a pathway for the individual is created to follow where the individual's points are weighted according to his/her health risks. As the health risks are adjusted, the individual's points and wellness program are adjusted as well.

Examples of such wellness programs tailored for individuals are as follows. Sally is 37 years old, does no exercise, only eats 2 servings of vegetables and fruit daily and is diabetic. In addition, she smokes, has a raised cholesterol level and is overweight. Her blood pressure is within the normal range, despite having a few alcohol based drinks each night.

Sally's calculated health age or health risk is 58. This is based on the relative risk that Sally's lifestyle and health factors pose. The fact that Sally smokes adds a certain risk to her from a mortality perspective with regards to chronic diseases of lifestyle. This is represented as an increased age. So each of these factors have a number linked to them with 1.0 being zero risk, less than 1.0 if the lifestyle factor such as exercise provides health benefits thus providing longevity and greater than 1 if a health risk is posed. This calculation changes over time as new clinical evidence develops. A tailored wellness program for Sally highlights the following areas of risk and allocates points to these areas.

TABLE 1

| | Increased Risk | Personal Points |
|---|---|---|
| Diabetes | 76 | 6,000 |
| Cholesterol | 68 | 5,500 |
| Smoking | 53 | 4,500 |
| BMI | 51 | 4,000 |
| Physical activity | 32 | 2,500 |
| Alcohol intake | 29 | 1 |
| Nutrition | 25 | 2,000 |

The number of points are calculated and allocated based on the individual's overall risk. For example, someone who has a risk that is double what it should be will be allocated 50% more points than someone who is healthy. The additional points that are allocated to the individual are linked to the various health and lifestyle risk factors that pertain to that individual. In this example the diabetes is the most significant risk factor so most of the points are allocated to that factor, then cholesterol etc. If insufficient physical activity is the only risk factor (as per example below) all the additional points will be allocated to that.

Based on the above Sally is allocated points if she met the following targets.

TABLE 2

| Sally's Wellness Personal | Available points | |
|---|---|---|
| Pathway | (24,000) | My personal goal |
| Manage your HbA1C | 6,000 | I will reduce my BMI by |
| Reduce your cholesterol | 5,500 | 10% in the next 3 months |
| Stop smoking! | 4,500 | |
| Lose weight | 4,000 | |
| Increase your physical | 2,500 | |
| activity | | |
| Improve your diet! | 2,000 | |
| Reduce your alcohol intake | Referral to | |
| | credible alcohol | |
| | partners (e.g. | |
| | AA; SANCA) | |

Where the goal is defined such as to stop smoking Sally is awarded all of the 4,500 points for stopping smoking and no points if she does not. However, where the goal is not so defined there is typically point amounts associated with the goal. So if Sally is asked to lose a certain amount of weight before she is allocated the 4,000 points for losing weight. This may be tiered so that reaching certain thresholds gives the individual access to certain rewards or greater rewards. The personal goal column is suggested by Sally after she has been shown what her risk factors are and she is then provided with additional incentive (points) to set a particular short term goal that she can choose from the list.

In another example, Bob is 31 years old, finds exercise difficult and does not like vegetables & fruit. He smokes and drinks alcohol in excess. Despite his unhealthy lifestyle habits, his health measurements are all in the normal range. His calculated health age is 37. A tailored wellness program for Bob highlights the following areas of risk and allocates points to these areas.

TABLE 3

| | Increased Risk | Personal Points |
|---|---|---|
| Smoking | 53 | 4,500 |
| Physical activity | 32 | 2,500 |
| Alcohol | 29 | 1 |
| Nutrition | 25 | 2,000 |

Based on the above Bob would be allocated points if he met the following targets.

TABLE 4

| My Wellness Personal | Available points | |
|---|---|---|
| Pathway | (9,000) | My personal goal |
| Stop smoking! | 4,500 | I will quit in the next 3 |
| Increase your physical | 2,500 | months |
| activity | | |
| Improve your diet! | 2,000 | |
| Reduce your alcohol intake | Referral to | |
| | credible alcohol | |
| | partners (e.g. | |
| | AA; SANCA) | |

In a further example, Alan is a healthy 40 year old male but needs encouragement to exercise a bit more—he currently manages about 45 minutes per week. His vegetable and fruit intake is average (4 servings daily) and his cholesterol is 4.5 mmol/l. His calculated health age is 41. A tailored wellness program for Alan highlights the following areas of risk and allocates points to these areas.

TABLE 5

| | Increased Risk | Personal Points |
|---|---|---|
| Physical activity | 32 | 1,000 |
| Nutrition | 25 | 500 |
| Cholesterol level | 23 | 500 |

Based on the above Alan would be allocated points if he met the following targets.

TABLE 6

| My Wellness Personal | Available points | |
|---|---|---|
| Pathway | (2,000) | My personal goal |
| Increase your physical | 1,000 | I will become fit enough to |
| activity | | reach level 4 at my next |
| Improve your diet! | 500 | Wellness Fitness |
| Manage your cholesterol | 500 | Assessment! |

In a final example, at 25 Jane is the picture of health. Jane's healthy lifestyle is keeping her calculated health well below her actual age. Her calculated health age is 22.5. Jane's only goal is therefore to maintain her current status. Jane may obtain points based on a general wellness program points structure, i.e., for going to gym, but is not be given any additional points as she is not at risk.

Once the member has his/her wellness program, information is received periodically regarding the individual's compliance or non-compliance with the wellness program. Points are awarded to the individual for compliance with the wellness program and in accordance with personal targets that have been set out. At predetermined intervals, the total number of points awarded to the individual is calculated and a reward and/or status level is then awarded to the individual based on the total number of points accumulated.

The user wellness program information 114 comprising the wellness program status level information is transmitted to the risk coverage provider system 102. The premium calculator 118 analyzes the received user wellness program information 116 to determine whether the policy holder's premium should be increased, decreased, or kept the same. For example, Table 7 below gives examples of how the premium calculator 118 can dynamically adjusts a policy holder's premium based on the wellness program status associated with the policy holder.

TABLE 7

| Vitality Status | Effort Threshold |
|---|---|
| Blue | +2.25% |
| Bronze | +1.50% |
| Silver | No Change |
| Gold | −1.00% |
| Platinum | −2.25% |

As can be seen, the premium calculator 118 can either increase, decrease, or keep the premium the same. For example, if the premium calculator 118 determines that the policy holder is not putting forth enough effort to maintain/improve his/her health (as indicated by a status of Blue or Bronze) then the premium calculator 118 increases the premium by a given amount. If the policy holder is not increasing or decreasing his/her health (as indicated by a status of Silver) the premium calculator 118 keeps the premium the same. If the premium calculator 118 determines that the policy holder is putting forth a strong or significant effort to maintain/improve his/her health (as indicated by a status of Gold or Platinum) then the premium calculator 118 decreases the premium by a given amount.

Additionally, the premium calculator 118 can give a new policy holder an initial premium discount. Then when a given interval of time has passed such as the policy term period (e.g., a year), the premium calculator 118 can determine whether to increase, decrease, or keep the premium the same based on the member's participation in one or more wellness programs, as discussed above. In another embodiment, the premium calculator 118 sets the initial premium to a given amount for all new members. The members are then only eligible for premium discounts when a given interval of time has passed such as the policy term period (e.g., a year). In yet another embodiment, the benefits of the wellness program can be flexible. For example, the wellness program status levels can be associated with a given amount of risk coverage that is lost or gained. In this example, when a member obtains a higher wellness program status level, additional coverage can be awarded, whereas a lower status level can have less coverage awarded to the member or taken away from the member.

As can be seen the various embodiments of the present invention enable risk coverage providers to perform dynamic underwriting. Allowing policy holders to participate in wellness programs and living verifiable healthy lifestyles the policy holders become healthier and receive deductions in their premiums. The risk coverage providers, thereby experience fewer claims and costs.

Operational Flow for Determining a Wellness Program Status

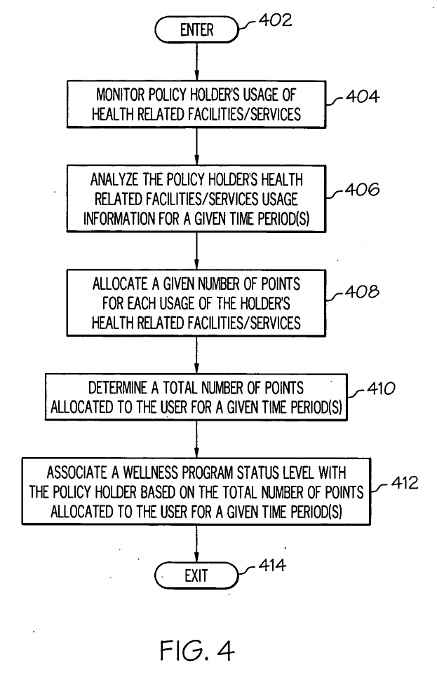

FIG. 4 is an operational flow diagram illustrating one process for determining a wellness program status for a risk coverage policy holder. The operational flow diagram beings at step 402 and flows directly to step 404. The wellness program manager 124, at step 404, monitors a policy holder's usage of health related facilities/services. The wellness program manager 124, at step 406, analyzes the policy holder's health related facilities/services usage information for a given time period(s). The wellness program manager 124, at step 408, allocates a given number of points for each usage of the holder's health related facilities/services for the given time period(s). The wellness program manager 124, at step 410, determines a number of points allocated to the user for a given time period(s). In an optional step, the wellness program manager 124, at step 412, associates a wellness program status level with the policy holder based on the total number of points allocated to the user for a given time period(s). In another embodiment, that the discount rewarded could be directly related to the total number of points and not to a status level. The control flow then exits at step 414.

Operational Flow for Dynamically Updating a Risk Coverage Premium Based on a Wellness Program Status of a Policy Holder

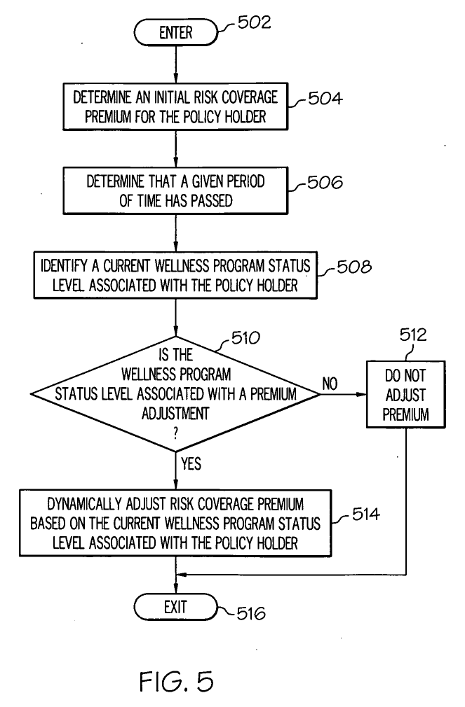

FIG. 5 is an operational flow diagram illustrating one process for dynamically updating a risk coverage premium of a policy holder based on a wellness program status associated therewith. The operational flow diagram beings at step 502 and flows directly into step 504. The premium calculator 118, at step 504, determines an initial risk coverage premium for the policy holder. The premium calculator 118, at step 506, determines that a given period of time has passed or expired. The premium calculator 118, at step 508, identifies a current wellness program status level associated with the policy holder. The premium calculator 118, at step 510, determines if the wellness program status level is associated with a premium adjustment. Again as mentioned previously, this could be optional in that the discount rewarded could be directly related to the total number of points and not to a status level If the result of this determination is negative the premium calculator 118, at step 512, does not adjust the policy holder's premium. The control flow then exits at step 516. If the result of this determination is positive the premium calculator 118, at step 514, dynamically adjusts the risk coverage premium based on the current wellness program status level associated with the policy holder. The control flow then exits at step 516.

Information Processing System

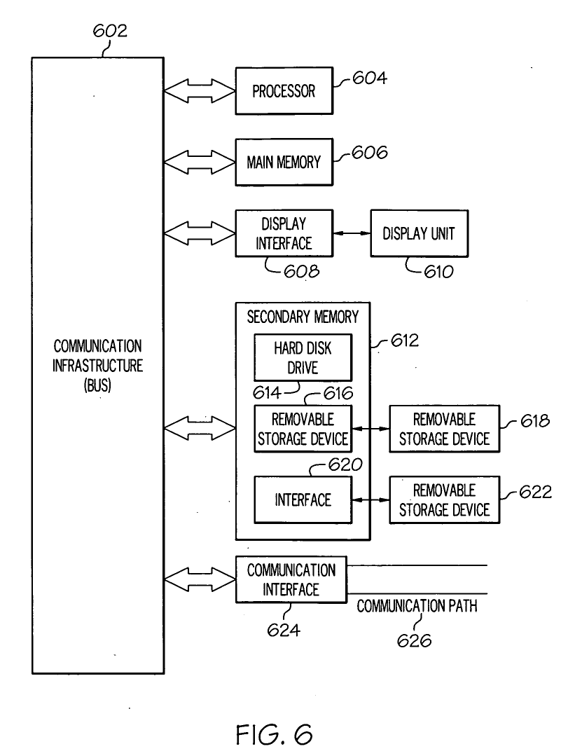

FIG. 6 is a high level block diagram illustrating a more detailed view of a computing system 600 such as any of the information processing systems 102, 104, 106, 108 useful for implementing the premium calculator 118 according to the various embodiments of the present invention. It should be noted that although the following discussion with respect to FIG. 6 is directed towards the risk coverage provider system server 102, the following discussion is also applicable to the other information processing systems 104, 106, 108 as well.

The computing system 600 is based upon a suitably configured processing system adapted to implement an exemplary embodiment of the present invention. For example, a personal computer, workstation, or the like, may be used. In one embodiment of the present invention, the computing system 600 includes one or more processors, such as processor 604. The processor 604 is connected to a communication infrastructure 602 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 600 can include a display interface 608 that forwards graphics, text, and other data from the communication infrastructure 602 (or from a frame buffer) for display on the display unit 610. The computing system 400 also includes a main memory 606, preferably random access memory (RAM), and may also include a secondary memory 612 as well as various caches and auxiliary memory as are normally found in computer systems. The secondary memory 612 may include, for example, a hard disk drive 614 and/or a removable storage drive 616, representing a floppy disk drive, a magnetic tape drive, an optical disk drive, and the like. The removable storage drive 616 reads from and/or writes to a removable storage unit 618 in a manner well known to those having ordinary skill in the art.

Removable storage unit 618, represents a floppy disk, a compact disc, magnetic tape, optical disk, etc. which is read by and written to by removable storage drive 616. As are appreciated, the removable storage unit 618 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 612 may include other similar means for allowing computer programs or other instructions to be loaded into the computing system 600. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computing system 600.

The computing system 600, in this example, includes a communications interface 624 that acts as an input and output and allows software and data to be transferred between the computing system 600 and external devices or access points via a communications path 626. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. The signals are provided to communications interface 624 via a communications path (i.e., channel) 626. The channel 626 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 606 and secondary memory 612, removable storage drive 616, and a hard disk installed in hard disk drive 614. The computer program products are means for providing software to the computer system. The computer readable medium allows the computer system to read data, instructions, messages or message packets, and other computer readable information from the computer readable medium.

Computer programs (also called computer control logic) are stored in main memory 406 and/or secondary memory 612. Computer programs may also be received via communications interface 624. Such computer programs, when executed, enable the computer system to perform the features of the various embodiments of the present invention as discussed herein. In particular, the computer programs, when executed, enable the processor 604 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for dynamically managing risk coverage premiums, the method comprising:
determining that a given time period has expired;
retrieving a risk coverage premium associated with a policy holder;
determining a wellness program level associated with the policy holder;
dynamically adjusting a current risk coverage premium based on the current wellness program level.

2. The method of claim 1, further comprising:
monitoring the policy holder's usage of at least one health related facility and/or service;
allocating a given number of points to the policy holder based on the policy holder's usage of the at least one health related facility and/or service; and
associating the wellness program status level with the policy holder based on the given number of points allocated to the policy holder.

3. The method of claim 1, wherein dynamically adjusting the current risk coverage premium further comprises:
dynamically increasing the risk coverage premium in response to the wellness program status level indicating that the policy holder is failing to maintain a healthy lifestyle.

4. The method of claim 1, wherein dynamically adjusting the current risk coverage premium further comprises:
dynamically decreasing the risk coverage premium in response to the wellness program status level indicating that the policy holder is maintaining a healthy lifestyle.

5. The method of claim 1, wherein determining a wellness program status level associated with the policy holder further comprises:
retrieving the wellness program status level from a third party.

6. The method of claim 1, wherein the wellness program status level is based on health related facility and/or service participation information associated with the policy holder.

7. The method of claim 6, wherein a risk coverage provider providing a risk coverage policy to the policy holder that is associated with risk coverage premium determines which health related facility and/or service the policy holder can participate in.

8. An information processing system dynamically managing risk coverage premiums, the information processing system comprising:
a memory;
a processor communicatively coupled to the memory; and
a premium calculator communicatively coupled to the processor and the memory, wherein the premium calculator is adapted to:
determine that a given time period has expired;
retrieve a risk coverage premium associated with a policy holder;
determine a wellness program status level associated with the policy holder;
dynamically adjust a current risk coverage premium based on the current wellness program status level.

9. The information processing system of claim 8, wherein the premium calculator is further adapted to:
monitor the policy holder's usage of at least one health related facility and/or service;
allocate a given number of points to the policy holder based on the policy holder's usage of the at least one health related facility and/or service; and
associate the wellness program status level with the policy holder based on the given number of points allocated to the policy holder.

10. The information processing system of claim 8, wherein the premium calculator is further adapted to dynamically adjust the current risk coverage premium by:
dynamically increasing the risk coverage premium in response to the wellness program status level indicating that the policy holder is failing to maintain a healthy lifestyle.

11. The information processing system of claim 8, wherein the premium calculator is further adapted to dynamically adjust the current risk coverage premium by:
dynamically decreasing the risk coverage premium in response to the wellness program status level indicating that the policy holder is maintaining a healthy lifestyle.

12. The information processing system of claim 8, wherein the premium calculator is further adapted to determine a wellness program status level associated with the policy holder by:
retrieving the wellness program status level from a third party.

13. The information processing system of claim 8, wherein the wellness program status level is based on health related facility and/or service participation information associated with the policy holder.

14. The information processing system of claim 13, wherein a risk coverage provider providing a risk coverage policy to the policy holder that is associated with risk coverage premium determines which health related facility and/or service the policy holder can participate in.

15. A computer program storage product for dynamically managing risk coverage premiums, the computer program storage product comprising instructions for:
determining that a given time period has expired;
retrieving a risk coverage premium associated with a policy holder;
determining a wellness program status level associated with the policy holder;
dynamically adjusting a current risk coverage premium based on the current wellness program status level.

16. The computer program storage product of claim 15, further comprising instructions for:
monitoring the policy holder's usage of at least one health related facility and/or service;
allocating a given number of points to the policy holder based on the policy holder's usage of the at least one health related facility and/or service; and
associating the wellness program status level with the policy holder based on the given number of points allocated to the policy holder.

17. The computer program storage product of claim 15, wherein the instructions for dynamically adjusting the current risk coverage premium further comprise instructions for:
dynamically increasing the risk coverage premium in response to the wellness program status level indicating that the policy holder is failing to maintain a healthy lifestyle.

18. The computer program storage product of claim 15, wherein the instructions for dynamically adjusting the current risk coverage premium further comprise instructions for:
dynamically decreasing the risk coverage premium in response to the wellness program status level indicating that the policy holder is maintaining a healthy lifestyle.

19. The computer program storage product of claim 15, wherein the wellness program status level is based on health related facility and/or service participation information associated with the policy holder.

20. The computer program storage product of claim 19, wherein a risk coverage provider providing a risk coverage policy to the policy holder that is associated with risk coverage premium determines which health related facility and/or service the policy holder can participate in.
